(19) United States
(12) Patent Application Publication
(10) Pub. No.: US 2016/0103645 A1
(43) Pub. Date: Apr. 14, 2016

(54) Method For Optimizing The Production Sequence

(71) Applicant: manroland web systems GmbH, Augsburg (DE)

(72) Inventors: Andreas Elchlepp, Aichach (DE); Franz Reismuller, Dasing (DE)

(73) Assignee: manroland web systems GmbH, Augsburg (DE)

(21) Appl. No.: 14/877,858

(22) Filed: Oct. 7, 2015

(30) Foreign Application Priority Data
Oct. 10, 2014 (DE) 10 2014 114 731.6

(51) Int. Cl. G06F 3/12; G06K 15/02

(52) U.S. Cl. CPC G06F 3/1275; G06F 3/1217; G06F 3/1262; G06F 3/1296; G06K 15/1809

(57) ABSTRACT

A method for optimising the production sequences of a plurality of printing orders assigned to a printing system is provided. When multiple printing orders are assigned to a specific printing system, each printing order on its own can be economically produced on the specific printing system, but economically optimal processing of the entirety of the printing jobs to be processed in a defined time interval is not thereby ensured. To increase the efficiency of the processing of a plurality of printing orders, the printing orders assigned to the printing system are arranged in their order and thus their sequence of processing in an automated manner, such that the printing orders assigned to the printing system can be produced in an optimised manner at least with regard to at least one sorting criterion. The method is applicable for sorting printing orders both for print form variable printing methods, as well as for non-print form variable printing methods and also for sheet-fed and/or reel-fed printing systems.

### CROSS REFERENCE TO RELATED APPLICATION

This United Stated non-provisional patent application claims the benefit of priority to German Patent Application No. DE 2014 114 731.6 filed on Oct. 10, 2014, the entire disclosure of which is incorporated herein by reference.

### BACKGROUND OF THE INVENTION AND RELATED ART

The invention relates to a method for optimising the production sequences of a plurality of printing orders assigned to a printing system, wherein the printing orders assigned to the printing system are arranged in their order and thus in their time sequence of processing in an automated manner such that the printing jobs assigned to the printing system can be produced in an optimised manner with respect to at least one criteria.

From the prior art, a method for the optimised processing of printing orders is known from DE 10 2013 102 756 A1, with which a printing order is assigned, as a function of the production parameters, either to a non-print form variable or print form variable printing system in order to ensure as economical as possible a processing of the respective printing order.

However, if multiple printing orders, which can also be called printing jobs, are assigned to a specific printing system or the processing of multiple printing orders by a printing system materialises per se, for example since only one printing system is available in the print shop or since the processing of different printing orders is only possible with a specific printing system, each printing order on its own can be economically produced on the specific printing system, but economically optimal processing of the entirety of the printing jobs to be processed in a defined time interval is not yet thereby ensured.

The individual printing orders to be processed by a printing system can have different production parameters, such as different web widths, substrate types, chromaticities, numbers of pages, end formats, fold types etc., so that as a rule setup processes are required from printing job to printing job which result in machine stoppage and in part substantially restrict the availability of the printing system.

It is true that the printing jobs to be produced on a printing system can be arranged with regard to the time sequence by a scheduler in such a manner that the setup changing processes between the individual printing jobs can be reduced. However, manual arranging in particular in the case of print form variable printing systems and/or different types of printing systems is no longer efficiently possible because of the small circulation figures and therefore because of a very high number of printing orders per day which nevertheless has to be produced economically.

The invention is therefore based on the object of creating a solution with which the printing jobs assigned to a printing system are sorted automatically or in an automated manner, i.e. without manual intervention of an operator or scheduler with regard to the sorting, in their time sequence or into processing audit according to certain criteria so that this total number of the printing orders can be produced in an economically optimal manner.

With the method according to the invention this object is solved in that the printing orders assigned to the printing system are automatically arranged in their order and thus in their sequence of processing that the printing orders assigned to the printing system can be produced in an optimised manner with respect to at least one sorting criterion.

From the prior art, printing systems are known, which consist of supplying and disposing of the substrate and various auxiliary components, such as for example drying devices as well as if appropriate from an associated post-processing device such as for example a cross cutting device, a folding device and/or a collecting and further processing device. Here it is immaterial regarding the present invention if a web-type material in the form of a reel is fed in as substrate or whether sheet-fed substrate is fed to the printing device.

It is likewise immaterial regarding the invention if the printing device or the printing system is a print form variable printing system or printing device, such as for example a digital printing press, which prints the substrate with the inkjet method or toner-based digital printing method or whether it concerns a so-called non-print form variable printing press such as for example an offset or intaglio printing press.

However, it is noted at this point that the method according to the invention is of interest in particular for print form variable printing systems, since these printing systems because of the system are preferentially employed for small and smallest editions. Accordingly, more printing orders are usually processed with print form variable printing systems in the same unit time than with non-print form variable printing systems. Accordingly, print form variable printing systems because of the generally higher number of printing orders usually have greater benefit from automated sorting than non-print form variable printing systems.

A printing order, also called printing job, is a print product, such as a book or a flyer, or a part of a print product, such as a signature of a magazine or catalogue when the final print product cannot be created in one production step. Non-print form variable printing systems, because of the limited circumference and the limited substrate width are limited in the number of pages that can be processed with a printing order.

A printing order is described by the printing order data which comprise the characteristics as well as the print contents. A printing order is described by the printing order data which comprise the characteristics as well as the printing contents. Printing order data are thus composed of the production parameters, such as for example the number of copies, the format of the print product, the substrate web, the substrate grammage, the fold type or also customer or logistical information, such as delivery addresses, delivery date, packaging unit etc., and the printing contents. The printing contents are fed to non-print form variable printing systems in the form of print forms, for example the printing plates. In the case of print form variable printing systems these are assigned to each printing order as digital data.

The printing orders assigned to a printing system are mostly processed and thus sorted in the form as they are assigned to the relevant printing system, or as they are to be delivered in the time sequence. Because of the different production parameters, it is highly probable with a time sequence of processing of the printing orders that because of the different and multiple production parameters, extended setup processes are required between many printing orders, for example in order to replace the substrate, change the chromaticity or in order to change the fold version.

Accordingly, with insufficient sorting of the printing orders, disproportionately long stoppage times due to setup changing processes can occur, for which mostly manual operator interventions are also required, which additionally increases the number of personnel required.

Manual sorting of the printing orders by a scheduler is possible in principle, but with a high number of printing orders to be processed, because of the multiple and varied production parameters, no continuous and sustainable as well as systematic optimisation can thereby be ensured, more so since different or combinable sorting criteria are possible or required. Since a more or less complex post-processing, such as for example a collecting or stacking station, a cutting station etc., which generally has to be set to the end format of the print product, are frequently arranged downstream of the printing system, these and their relevant production parameters have to be additionally considered for sustainable optimisation, which renders manual sorting additionally difficult.

Furthermore, there are different sorting criteria. Accordingly, the printing orders can be optimised regarding economic aspects of the pure print production, which means that generally the totality of the stoppage and setup changing times, for example for substrate change, format changes, of the post-processing arranged downstream of the printing system, the changing of the fold or the web lead etc., are minimised.

Under certain conditions it can also be practical to optimise the printing orders for example according to logistical aspects. Here, the sequences are not mandatorily optimised purely regarding the printing system but in this case aspects of the dispatch space or of the dispatch for example are also considered. If for example different print products in a variable number are scheduled for each customer in each case, it can be quite logical to sort the printing orders so that all print products assigned to a specific customer are produced in a continuous order so that the logistics following the printing and post-processing is thereby simplified. This can be logical, in particular in the case of print form variable printing systems, since no machine stoppages for changing the printing data or subjects are mostly required here.

Depending on the functioning and configuration of the printing system, and if applicable of the downstream post-processing, further criteria such as the chromaticity, the print quality or for example the configuration of the post-processing with adjustable configurations of the same are possible.

### SUMMARY OF THE INVENTION

In a preferential embodiment of the invention, the operator can select from different predefined sorting criteria since these are parametrised in the operating unit and are configurably embodied in an advantageous configuration.

When multiple sorting criteria are not in conflict with one another, a plurality of search criteria with appropriate prioritisation can also be selected, if required.

For sorting the printing orders, the production parameters of the printing orders to be sorted are divided and analysed according to the at least one sorting criterion. To this end, the printing orders, for example with the relevant production parameters, are spread out matrix-like and the respective printing orders regarding their respective production parameters are compared and sorted such that between each preceding and following printing order either no or preferably low differences of the production parameters, in particular of the stoppage-relevant production parameters, are incurred. Since no difference between the production parameters of successive printing orders means no production interruption for setup processes—with the exception of changing the at least one print form in the case of non-print form variable printing systems—sorting of the printing orders can thus be achieved preferably with short time required for setup and as a rule with the least possible need for operating personnel.

Furthermore, the method and the device configured for this purpose can also be designed so that the printing orders are not only compared with one another and sorted in the form that in each case no or preferably little difference is obtained between the production parameters, but that with a correspondingly pronounced difference between specific production parameters a change or adaptation of the production parameters is suggested in order to minimise the number of required setup processes and thus the totality of the setup time. This is logical, for example in the case of substrate widths that do not deviate too greatly, in particular when the slightly greater trim with larger web width than required constitutes a smaller economical disadvantage compared with an additional setup process.

### BRIEF DESCRIPTION OF THE DRAWINGS

Different exemplary embodiments of the invention are explained in more detail with the help of the following drawings, without being restricted thereto.

FIG. 1a shows a sequence of printing orders without or prior to the sorting according to economically optimal aspects.

FIG. 1b shows a sequence of printing orders after the sorting according to economically optimal aspects for a print form variable printing system according to an exemplary embodiment of the present invention.

FIG. 1c shows a sequence of printing orders after the sorting according to economically optimal aspects for a non-print form variable printing system according to an exemplary embodiment of the present invention.

FIG. 2 shows a matrix of the production parameters regarding the corresponding printing orders to be sorted according to an exemplary embodiment of the present invention.

### DETAILED DESCRIPTION OF EXEMPLARY EMBODIMENTS

The following exemplary embodiment(s) of the invention are shown and described with reference in each case to a print form variable and a non-print form variable printing system with integrated folding device, wherein it is expressly noted that the same can also be transferred to sheet-processing printing systems with suitable adaptations.

The print form variable printing system is embodied for example in the form as described in the publications EP 2 308 681 A2 or DE 10 2012 103 729 A1.

Non-print form variable reel-fed printing systems, such as reel-fed offset, reel-fed intaglio or for example reel-fed flexographic printing press, are well known to a person skilled in the relevant art.

For the sake of simplicity, the method is explained on the example of five printing orders with, in each case, a reasonable number of production parameters considered for sorting. It is self-explanatory that with an automated method both the number of the printing orders to be sorted as well as the number of the production parameters and sorting criteria to be considered can be expanded as desired.

Printing job 10-1 is a 4-colour 16-page job in the A4 format with the end dimensions 299 mm×210 mm, printed on a paper with a grammage of 80 g/m²; the product size and the number of pages result for example in a web width of 840 mm.

Printing job 10-2 is a 4-colour 24-page job in the A4 format with the end dimensions 290 mm×205 mm, printed on a paper with a grammage of 80 g/m²; the product size and the number of pages result for example in a web width of 820 mm.

Printing job 10-3 is a unicolour 32-page job in the A5 format with the end dimensions 210 mm×150 mm, printed on a paper with a grammage of 60 g/m²; the product size and the number of pages result for example in a web width of 900 mm.

Printing job 10-4 is a 4-colour 8-page job in the A4 format with the end dimensions 299 mm×210 mm, printed on a paper with a grammage of 80 g/m²; the product size and the number of pages result for example in a web width of 840 mm.

Printing job 10-5 is a 4-colour 4-page job in the format smaller than A4 format with the end dimensions 280 mm×190 mm, printed on a paper with a grammage of 100 g/m²; the product size and the number of pages result for example in a web width of 760 mm.

The production planning and control device or system, which is required for carrying out the method according to the invention, comprises an acceptance interface for accepting printing order data 11 representing the printing orders and production parameters 12 relevant for analysis and sorting. Such printing order data 11 can for example be the output data of a production planning system. The acceptance interface is designed for example as a conventional network interface, but could also be formed for example by way of a fixed wiring or as a pure software interface.

The production planning and control system furthermore comprises a computer device designed as a sorting device with suitable storage facility, which is designed for analysing and sorting the printing orders 10 to be sorted or optimised with regard to the sequence.

The production planning and control device furthermore comprises an input unit, by means of which production parameters can be input, changed or corrected. In addition to this, the sorting criteria can also be input, adapted or selected with the input unit.

Furthermore, the production planning and control device comprises a display device, by means of which the printing orders 10 to be analysed, the printing order data 11 associated with the printing orders 10 can be visualised in original and optimised sequence with suitable additional comments for the operator or the scheduler. It goes without saying that such information can also be stored, printed or converted to other data formats.

The production parameters 12, for which in a particularly advantageous manner of the invention an adaptation of the production parameters 12 was independently carried out by the production planning and control system or a change regarding the same is suggested for further optimising the total production sequences are also displayed for example on this display device. In the event that the control system suggests changes, these can be accepted or rejected by the operator of the control system by means of one of the input units.

Once the method for optimising the production sequence according to the invention has been carried out, the correspondingly arranged order data are transferred to a further control device, which serves for controlling the processing of the printing orders 10 of the relevant printing press.

These mentioned, different control systems can also be installed in terms of hardware in a single computer so that the respective functions are merely realised by different control modules.

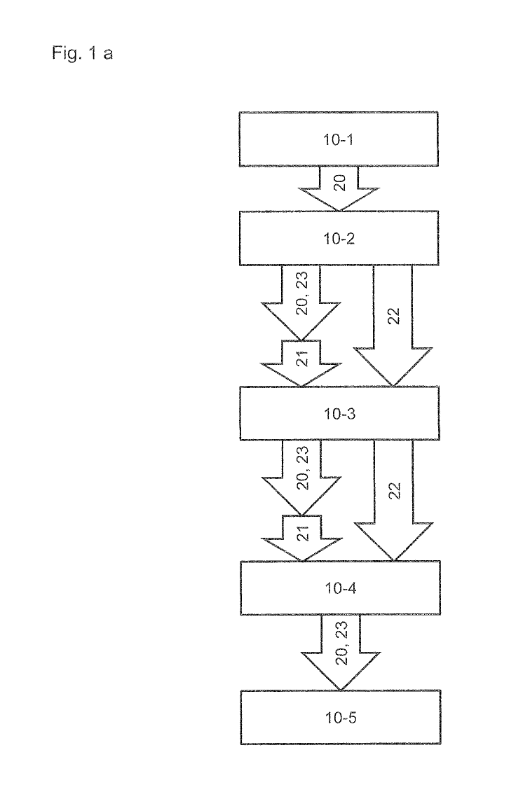

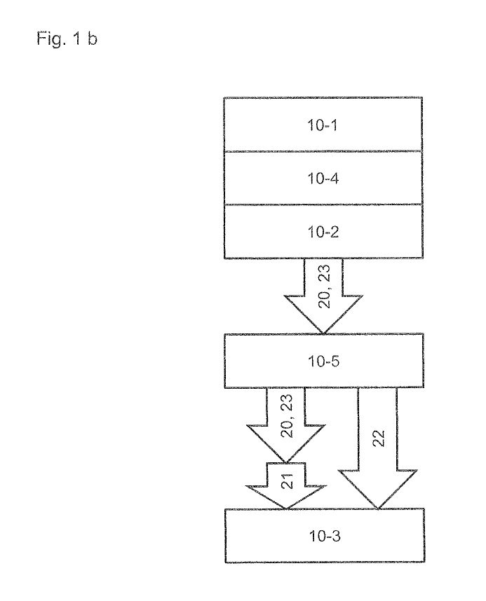

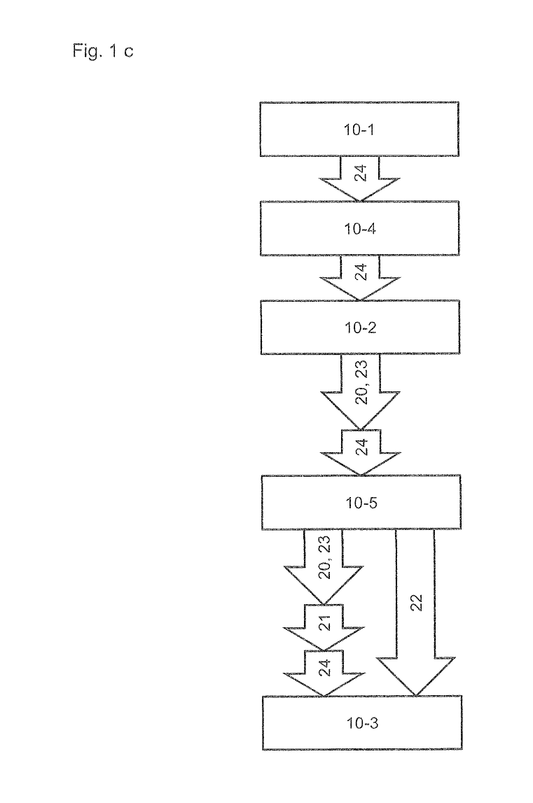

Without further sorting of the sequence of these printing orders 10, namely printing jobs 10-1 to 10-5, strongly raised expenditures result because of the numerous required setup processes according to FIG. 1a. For after completion of the printing order 10-1, at least the substrate has to be changed for the production of the printing order 10-2 in order to ensure the change of the substrate width 20. Because of the other format, additional settings on the folder or in particular on the post-processing devices, such as for example a stacking or collecting device arranged downstream of the former, are additionally incurred.

Following completion of the printing order 10-2, the folding format—dependent on the embodiment of the folder—has to be changed, for the purpose of which it is frequently necessary to remove the substrate from the folder, which requires manual interventions. If applicable, the format of the folder and of the downstream post-processing has to be adapted to the new product size. Furthermore, the change of the chromaticity from a four-colour to a unicolour print dependent on the type of the printing device can require a setup process, or at least a machine stop, even in the case of print form variable printing devices. However, in addition, the substrate has to be changed in any case since for the printing order 10-3 a different substrate width and also a different paper grammage is required. Changing the substrate width 20 and changing over the grammage of the substrate 23 requires manual operator invention in most cases and thus correspondingly long stoppage or change of setup times. Additionally, such manual interventions as changing the substrate and changing over the folder can generally be carried out only sequentially and not at the same time, at least assuming an economically justifiable number of machine personnel. Changing over the chromaticity 22 can mostly take place in parallel with the setup process described above.

Following completion of the printing order 10-3 and changing to the printing order 10-4, the same setup processes with the more or less same stoppage times and personnel requirements are likewise required again as during the change of printing job 10-12 to 10-3.

During the subsequent change from printing job 10-4 to printing job 10-5, at least one change of the substrate is required for changing the substrate width 20 and changing over the grammage, if applicable—dependent on the machine and folder configuration—the folder additionally has to be changed over and because of the different product end size, components located downstream of the folder, adjusted or adapted.

This example illustrates that with non-optimised processing of printing orders 10, partly highly time and personnel-consuming setup processes are required, which significantly restrict the availability, the productivity and thus the economy of such a system.

However, if the printing orders 10 assigned to a printing system are analysed according to at least one sorting criterion 15, such as for example the substrate width, substrate grammage, minimal setup or stoppage times, the fastest production of various printing orders 10, lowest possible production costs, fewest possible changes of the substrate and/or the type of fold, and sorted according to the smallest consecutive deviations of the sorting criteria, the number of setup processes and thus the setup or stoppage times as well as the personnel required for this purpose can be significantly reduced through the modified sequence of processing.

FIG. 1b shows a possible result of sorting according to these three sorting criteria for a print form variable printing system. Accordingly, the printing orders 10-1 and 10-4 for example can be produced in succession on the same web width and grammage without interruption—provided the folder is suitably configured.

Since the printing order 10-2 requires a slightly deviating web width, a change of the substrate width would actually be required between printing job 10-4 and 10-2.

According to a particularly advantageous embodiment of the invention, the system required for carrying out the method according to the invention can also be carried out such that with certain changes of production parameters 12 it is proposed to suitably adapt these respective production parameters 12 in order to avoid one or multiple setup processes. An example for this is the web width: instead of the web width of 820 mm required for printing job 10-2 it can be proposed, to avoid a change of the substrate width 20, to use the wider substrate with a width of 840 mm already present in the machine. This is interesting in particular when the economic disadvantage through the trimming that is then required is smaller than the economic disadvantage through an additional setup process. Suitable adaptations can be made for example regarding web width, the substrate grammage or the substrate quality provided these can be reconciled with the customer requirements. For such a solution, the direction of the consecutive production parameters 12 and the deviation of the actual production parameter 12 with respect to the production parameter 12 originally preset or required for which a suitable change is suggested has to be parametrised for the respective sorting criteria.

Following completion of the printing job 10-2 with a substrate width of 840 mm, merely a change of the substrate web 20 and also a changeover of the substrate grammage 23, i.e. a change of the substrate, is required for the following production of the printing job 10-5.

Following completion of the printing job 10-5, a more extensive change of setup process with a change of the substrate width 20, a change of the substrate grammage 23, a changeover of the folder with adaptation of the folding format 21 as well as a changeover of the chromaticity 22 is required, which however cannot be avoided because of the production parameters 12 demanded for the printing job 10-3.

However, this example already illustrates that through suitable sorting of printing jobs the overall effort of the setup processes and thus of stoppage times of the printing system 1 resulting from these can be significantly reduced.

Since a suitable analysis and sorting of printing orders 10 can also be practical for non-print form variable printing systems, in particular when a highly complex printing system with for example a plurality of additional components, such as inline finishing units, such as perforating or coating units, plough folding devices, etc. is concerned and/or a plurality of printing orders 10 with small circulation are printed, a suitably optimised production order of printing orders 10 for a non-print form variable printing system is shown in FIG. 1c.

In principle, this corresponds to the sequence optimised regarding setup times in principle as for the print form variable printing system 1. However, due to the system, a print form change 24 is required in the case of non-print form variable printing systems before a new printing order 10. However, a print form change 24 is mostly automated in modern non-print form variable printing systems 1 and results in only short stoppage times with no personnel required for the pure changing process.

As shown by the example of FIG. 1a, either sorting according to a sorting criterion 15, such as for example the web width, can be adequate dependent on the product structure, such as for example with very similar print products and/or with a relatively simple configuration of a printing system 1. Even when sorting a quantity of printing orders 10 takes place only according to one sorting criterion, different sorting criteria 15 can nevertheless be required or advantageous time and again for different quantities of printing orders 10.

However, if the usual product structure of a printing system 1 has highly different print products and/or the printing system has a very high degree of complexity or variability, sorting according to multiple sorting criteria 15, such as for example the substrate width, the grammage, the chromaticity, the end format of the print product, etc., can be required. In particular with such complex product structures or sorting criteria, efficient manual sorting by the operator or the scheduler of a printing system can no longer be ensured, in particular considering that modern print form variable printing systems being able to process several hundred printing orders 10 per day and dependent on the complexity of the printing system 1, easily 10 to 20 different production parameters 12 have to be considered even if these are not always simultaneously relevant to setup time.

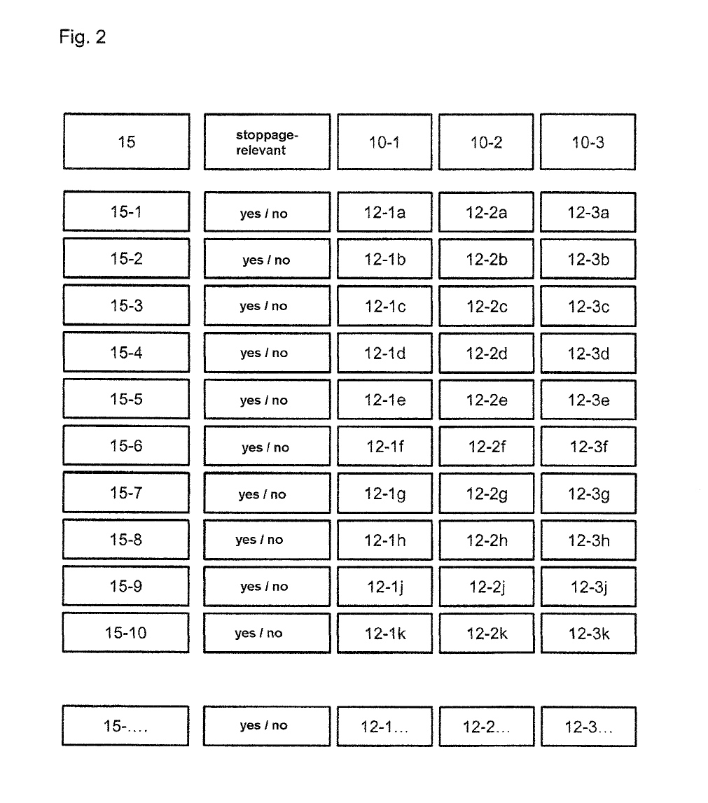

For analysing and sorting, the printing order data 11 of the printing orders 10 are divided regarding their respective production parameters 12 and for analysis spread for example in a matrix. FIG. 2 shows an exemplary embodiment of a corresponding matrix.

In such a matrix, the relevancy of the respective production parameter 12 or the relevancy of the change of the respective production parameter 12 between consecutive production parameters 12 can be parametrised, for example that the substrate web has to be replaced when the subsequent production requires a greater web width than is used with the previous production, or that a machine stop with removal of the paper from the folder is required when the folder has to be changed over, for example from a so-called cross fold to a delta fold.

Furthermore, in a particularly advantageous embodiment of the invention the production parameters 12 and the prerequisites under which these can be proposed for adaptation can also be parametrised in order to avoid additional setup operations. Accordingly, it can be parameterised for example for the production parameter 12 “substrate width” that for a printing order 10 an adaptation to a larger web width is proposed when the substrate width of the previous printing order 10 is greater than the actual web width required for the printing order under consideration. Furthermore, variation spaces can also be defined here that for example the use of a greater substrate width is only proposed in particular when the same does not exceed a certain percentage or absolute amount compared with the substrate web width demanded for the printing order 10 under consideration. Accordingly it can be parameterised for example that the use of a web that is wider than actually required for avoiding setup processes is only proposed when the difference of the previous web width from the actually required web width does not exceed for example 10% of the actually required web width.

For sorting the printing order 10, at least one sorting criterion 15 is furthermore required. As sorting criteria 15, either certain production parameters 12 can be directly selected so that for example the printing orders 10 are sorted according to the web width and/or other production parameters 12. However, one or multiple relevant production parameters 12 can also be combined as sorting criterion 15 into a group with appropriate context.

Since in the matrix, the respective production parameters if appropriate can be assigned a relevancy as described above, for example that a change of the folding format requires a machine stoppage, one or multiple stoppage-relevant production parameters can be combined into a sorting criterion 15 of a stoppage relevancy.

If the printing orders 10 to be analysed and sorted are to be sorted such that the sum of the printing orders with the lowest possible stoppage times are produced, all relevant production parameters 12 for sorting can be activated by selecting this sorting criterion 15 by way of which it is avoided that the operator forgets activating relevant production parameters as sorting criterion 15, and thus would achieve only a sub-optimal result in terms of economy.

In a further advantageous embodiment of the invention, at least one such sorting criterion 15 can be defined and in the case of multiple defined sorting criteria, the at least one sorting criterion 15 can be selected from a list of all predefined sorting criteria. Advantageously, in the event of multiple sorting criteria being activated, these can be checked for contradiction and in the event of a detected contradiction of at least one sorting criterion 15, an error message is displayed.

Since the configuration of the relevant printing system is variable in principle and in particular the post-processing arranged downstream of the printing system can be modified, expanded or reconfigured, the at least one sorting criterion 15 or the list of the predefined sorting criteria can be freely configured in a further particularly advantageous embodiment of the invention in order to be able to adapt these to changes of the printing system or the downstream post-processing.

Partly, the printing systems consisting of at least one feed for the substrate, the printing device for applying the print image onto the substrate and a disposal unit, for example in the form of a re-winder, cross cutter or folder, are already highly complex and have correspondingly mini production parameters 12, in particular when addition or highly complex components, such as for example additional coating devices, in-line finishing components, such as for example perforating or punching devices, numbering units, printing systems for personalisations, such as for example inkjet imprints etc., are integrated in the printing system, in particular when these additionally permit different web leads as well.

However, a partly just as complex a post-processing, such as collecting or stacking devices, trimming devices, stitching or gluing stations, packaging stations, etc., are arranged downstream of such a printing system, in the case of which numerous and highly varied production parameters 12 have to be likewise considered. Partly, these production parameters 12 of the post-processing components are also stoppage-relevant, i.e. a change of the production parameters 12 of two consecutive printing orders 10 can render a setup process and if applicable a concomitant stoppage necessary, for example when these components have to be adjusted to a new format or a new size of a print product, or when for certain functions, adjustments to the relevant product have to be carried out, such as for example in the case of stitching devices.

Since however during optimisation of sequences or for example the economy only a consideration of the entire component combination required for producing the respective print product, are consisting of printing system and downstream post-processing is practical and sustainable, the at least one post-processing or post-processing line associated with the printing system and the post-processing system and the post-processing production parameters 12 of the same associated with the printing system are included in the evaluation of the production parameters 12 and in the sorting of the respective printing orders 10.

The present examples all show an optimisation according to setup time-relevant sorting criteria, such as shortening the stoppage times, avoiding unnecessary manual change of setup processes, etc., since change of setup processes lower the availability of the equipment required for producing a print product, partly make a high number of personnel necessary and also increase the error quota or mean additional time and material needed for setting processes.

Accordingly, a particularly advantageous embodiment of the present invention is that the order of the printing orders is optimised according to at least one setup time-relevant sorting criterion 15, such as minimal stoppage times of the printing system, preferably few changes of the substrate, etc.

However, in particular in the case of printing systems, in the case of which print products in very small editions, for example circulation figures of approximately 5 to 50 printed copies or for example print products with personalised, i.e. customer-specifically configured printing contents, such as for example advertising brochures related to a specific business or branch, brochures or a specific number of journals or newspapers for each news outlet or other sales or display location, the expenditure and thus the costs for logistics, the scheduling and dispatch make up a substantial component of the overall process or the overall costs, but also of the required time span from production to dispatch. Furthermore, in the case of such a production range and dispatch sections that are different or different in length, the delivery times have to be considered also in a sensitive and precise manner.

This example shows that in addition to the pure stoppage-relevant sorting criteria, other sorting criteria which in part are not purely related to the printing system, are or can be relevant.

Thus, according to a further advantageous embodiment of the invention, the order of the printing orders 10 assigned to the printing system under consideration, as well as optionally assigned to the post-processing downstream of the printing system, are sorted according to at least one sorting criteria 15 of the logistic, for example of the consecutive production of all products belonging to a specific customer.

In the case of such sorting criteria 15 it goes without saying that customer-related or logistics-related data with such requirements have to be included in the production parameters 12 of the respective printing orders 10.

Such different sorting criteria 15 need not in principle contradict one another. However, too many sorting criteria 15 can result in a breakdown of the sorting process. For this reason, when selecting multiple sorting criteria 15, these can be advantageously prioritised regarding their relevancy.

Since an analysis of production parameters 12 and the sorting of printing orders 10 that is thereby possible is independent of the printing method, substrates or applications, it is obvious that the method according to the invention can be applied for sorting printing orders both for print form variable printing methods, such as the inkjet method or for example toner-based digital printing methods, as well as for non-print form variable printing methods, such as for example offset printing, intaglio printing, letterpress printing, flexographic printing etc., and can be applied to all the aforementioned printing methods also for both sheet-fed and/or reel-fed printing systems.

Furthermore, for realising methods according to the invention, a device in the form of a control or computer is desirable, which is likewise part of the present invention.

That which is claimed is:

1. A method for optimizing a production sequence of a plurality of printing orders assigned to a printing system, comprising:
arranging the printing orders assigned to the printing system in an order of the printing orders and a sequence of processing using at least one sorting criterion in an automated manner.

2. The method according to claim 1, wherein the printing orders are defined by a plurality of printing order data assigned to the printing system and wherein the printing order data are analyzed and evaluated for sorting according to at least one production parameter.

3. The method according to claim 2, wherein the printing order data for analysis and evaluation are broken up into a plurality of production parameters selected from the group consisting of substrate web width, substrate format, substrate type, color profile, chromaticity and fold type.

4. The method according to claim 1, wherein the at least one sorting criterion is selected from a predetermined plurality of predefined sorting criteria.

5. The method according to claim 4, wherein the at least one sorting criterion or the predefined sorting criteria is freely configurable.

6. The method according to claim 2, wherein at least one post-processing line associated with the printing system and the post-processing production parameters corresponding to said post-processing line are included in the evaluation of the production parameters and the sorting of the respective printing orders.

7. The method according to claim 1, wherein the order of the printing orders is optimized according to at least one setup time-relevant sorting criterion selected from the group consisting of minimal stoppage times of the printing system and as few as possible changes of the substrate.

8. The method according to claim 1, wherein the order of the printing orders assigned to the printing system is sorted according to at least one sorting criterion of logistics comprising a consecutive production of all print products belonging to a specific customer.

9. The method according to claim 1, further comprising selecting a plurality of sorting criteria prioritized by relevancy.

10. The method according to claim 1, wherein the printing system is selected from the group consisting of sheet-fed and reel-fed printing systems.

11. The method according to claim 1, wherein the printing system is selected from the group consisting of non-print form variable and print form variable printing systems.

12. The method according to claim 2, further comprising adapting the production parameters for relevant printing orders so that the printing orders assigned to the printing system are additionally optimized in order and sequence of processing with respect to at least one sorting criterion.

13. A programmable device for performing the method according to claim 1.
